(19) United States
(12) Patent Application Publication
(10) Pub. No.: US 2026/0274132 A1
(43) Pub. Date: Sep. 17, 2026

(54) Vehicle Seat Assembly

(71) Applicant: Proprietect L.P., Toronto (CA)

(72) Inventors: Mark D. Weierstall, Roseville, MI (US); Kevin Liping Dong, Woodbridge (CA); Andrew Cappuccitti, Concord (CA); Todd Skrabut, Sterling Heights, MI (US); Henry Edward Hojnacki, Sterling Heights, MI (US)

(73) Assignee: Proprietect L.P., Toronto, ON (CA)

(21) Appl. No.: 19/164,704

(22) PCT Filed: Mar. 15, 2024
(86) PCT No.: PCT/IB2024/052561

§ 371 Date: Sep. 12, 2025

Related U.S. Application Data
(60) Provisional application No. 63/490,506, filed on Mar. 15, 2023.

(51) Int. Cl. B60N 2/70

(52) U.S. Cl. CPC B60N 2/7094; B60N 2/7047

(57) ABSTRACT

The subject disclosure provides a vehicle seat assembly comprising a seat component having a support surface, a foam layer, and a formed cloth. The foam layer has an A-surface and a B-surface. The formed cloth has an inner surface and an outer surface with the inner surface attached to the B-surface of the foam layer. The formed cloth comprises a plurality of fibers shaped to define a plurality of suspension springs each having a pre-defined 3-dimensional configuration defining a cavity. Each cavity is filled with a portion of the foam layer and the foam layer at least partially penetrates the formed cloth between the inner and outer surfaces to further define the suspension springs and to maintain the pre-defined 3-dimensional configurations of the suspension springs. A portion of the outer surface of the formed cloth on the suspension springs engages the support surface of the seat component. The suspension springs respond to dynamic input by partially deflecting to a deflected state and recovering to an initial state relative to the support surface of the seat component for isolating vibrations of an occupant during use of the vehicle seat assembly.

### FIELD OF DISCLOSURE

The subject disclosure generally relates to a vehicle seat assembly.

### BACKGROUND

The automotive industry continues to evolve to accommodate sleeker designs with aerodynamic shapes and minimalistic lines. With that comes the challenge of accommodating this emphasis on style without sacrificing performance or customer comfort. Market trends are pushing vehicles to have sleek rooflines, which can shorten the height of the vehicle and create less headroom for the occupants.

Traditional vehicle seat assemblies include suspension systems that help dampen road noise and isolate high impact vibrations such as running over a pothole. These suspension systems include metallic springs, shock absorbers, and sway bars. However, these traditional suspension systems can be bulky and take up considerable space within the vehicle.

There exists a need in the field to effectively balance the aesthetics of modern vehicle design and occupant comfort.

### SUMMARY

The subject disclosure provides a vehicle seat assembly comprising a seat component having a support surface, a foam layer, and a formed cloth. The foam layer has an A-surface and a B-surface opposite to the A-surface with the B-surface facing the support surface of the seat component. The formed cloth has an inner surface and an outer surface with the inner surface attached to the B-surface of the foam layer. The formed cloth comprises a plurality of fibers shaped to define a plurality of suspension springs each having a pre-defined 3-dimensional configuration defining a cavity. Each cavity is filled with a portion of the foam layer and the foam layer at least partially penetrates the formed cloth between the inner and outer surfaces to further define the suspension springs and to maintain the pre-defined 3-dimensional configurations of the suspension springs. A portion of the outer surface of the formed cloth on the suspension springs engages the support surface of the seat component. The suspension springs respond to dynamic input by partially deflecting to a deflected state and recovering to an initial state relative to the support surface of the seat component for isolating vibrations of an occupant during use of the vehicle seat assembly.

The subject disclosure also provides for a foam seat assembly for use in the vehicle seat assembly having the seat component defining the support surface. The foam seat assembly comprises the foam layer, and the formed cloth. The foam layer has the A-surface and the B-surface opposite the A-surface with the B-surface adapted to face the support surface of the seat component. The formed cloth has the inner surface and the outer surface with the inner surface attached to the B-surface of the foam layer. The formed cloth comprises the plurality of fibers shaped to define the plurality of suspension springs each having the pre-defined 3-dimensional configuration defining the cavity. Each cavity is filled with the portion of the foam layer and the foam layer penetrates the formed cloth between the inner and outer surfaces to further define the suspension springs and to maintain the pre-defined 3-dimensional configurations of the suspension springs. The suspension springs respond to dynamic input by partially deflecting to the deflected state and recovering to the initial state for isolating vibrations of the occupant during use of the foam seat assembly when the portion of the suspension springs engage the support surface of the seat component and move between the initial and deflected states relative to the support surface of the seat component.

The subject disclosure also provides for the foam seat assembly for use in the vehicle seat assembly having the seat component defining the support surface. The foam seat assembly includes the foam layer and the formed cloth. The foam layer having the A-surface and the B-surface opposite the A-surface with the B-surface adapted to face the support surface of the seat component. The formed cloth having the inner surface and the outer surface with the inner surface attached to the B-surface of the foam layer. The formed cloth comprising the plurality of fibers shaped to define the plurality of suspension springs each having the pre-defined 3-dimensional configuration defining the cavity with the cavity having an opening extending through the inner and outer surfaces. Each cavity is filled with the portion of the foam layer. The foam layer penetrating the formed cloth between the inner and outer surfaces to further define the suspension springs and to maintain the pre-defined 3-dimensional configurations of the suspension springs. The foam layer extending at least into the opening of the formed cloth. The suspension springs respond to dynamic input by partially deflecting to the deflected state and recovering to the initial state for isolating vibrations of the occupant during use of the foam seat assembly when at least one of a portion of the suspension springs and the portion of the foam layer extending into the opening engage the support surface of the seat component and move between the initial and deflected states relative to the support surface of the seat component.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a perspective view of a vehicle seat assembly.

FIG. 2A is an exploded view of a first embodiment of a seat bottom of the vehicle seat assembly.

FIG. 2B is an exploded view of a second embodiment of a seat bottom of the vehicle seat assembly.

FIG. 3 is an exploded view of a seat back of the vehicle seat assembly.

FIG. 4 is a top cross-sectional perspective view of a foam seat assembly in accordance with the subject invention.

FIG. 5 is a bottom cross-sectional perspective view of the foam seat assembly.

FIG. 6 is an enlarged fragmented perspective view of the foam seat assembly showing a first embodiment of a plurality of suspension springs shaped as cuboids having curved edges.

FIG. 7 is another enlarged fragmented perspective view of the foam seat assembly showing a second embodiment of the plurality of suspension springs shaped as cuboids having curved edges.

FIG. 8A is a fragmented cross-sectional side view of the vehicle seat assembly having the suspension springs shown in FIG. 7 in an initial state.

FIG. 8B is another fragmented cross-sectional side view of the vehicle seat assembly having the suspension springs shown in FIG. 7 in a deflected state.

FIG. 9 is another enlarged fragmented perspective view of the foam seat assembly showing a third embodiment of the plurality of suspension springs shaped as pyramids.

FIG. 10A is a fragmented cross-sectional side view of the vehicle seat assembly having the suspension springs shown in FIG. 9 in the initial state.

FIG. 10B is another fragmented cross-sectional side view of the vehicle seat assembly having the suspension springs shown in FIG. 9 in the deflected state.

FIG. 11 is another enlarged fragmented perspective view of the foam seat assembly showing a fourth embodiment of the plurality of suspension springs shaped as pyramids.

FIG. 12A is a fragmented cross-sectional side view of the vehicle seat assembly having the suspension springs shown in FIG. 11 in the initial state.

FIG. 12B is another fragmented cross-sectional side view of the vehicle seat assembly having the suspension springs shown in FIG. 11 in the deflected state.

FIG. 13 is another enlarged fragmented perspective view of the foam seat assembly showing a fifth embodiment of the plurality of suspension springs shaped as bases with pyramids.

FIG. 14A is a fragmented cross-sectional side view of the vehicle seat assembly having the suspension springs shown in FIG. 13 in the initial state.

FIG. 14B is another fragmented cross-sectional side view of the vehicle seat assembly having the suspension springs shown in FIG. 13 in the deflected state.

FIG. 15 is another enlarged fragmented perspective view of the foam seat assembly showing a sixth embodiment of the plurality of suspension springs shaped as bases with domes.

FIG. 16A is a fragmented cross-sectional side view of the vehicle seat assembly having the suspension springs shown in FIG. 15 in the initial state.

FIG. 16B is another fragmented cross-sectional side view of the vehicle seat assembly having the suspension springs shown in FIG. 15 in the deflected state.

FIG. 17 is a perspective view of three sample portions of the foam seat assembly illustrating three different levels of foam layer penetration into the formed cloth.

FIG. 18 is a graph showing the effect of different levels of the foam layer penetrating into the singular formed cloth suspension spring as shown in FIG. 17.

FIG. 19 is an enlarged fragmented cross-sectional side view of a suspension spring illustrating varying percentages of penetration of the foam layer into the formed cloth.

FIG. 20 is an enlarged fragmented perspective view of the foam seat assembly showing a seventh embodiment of the plurality of suspension springs shaped as cuboids having curved edges and with openings.

FIG. 21 is a fragmented cross-sectional side view of the vehicle seat assembly having the suspension springs shown in FIG. 20 in the initial state.

FIG. 22 is an enlarged fragmented perspective view of the foam seat assembly showing an eighth embodiment of the plurality of suspension springs shaped as pyramids and with openings.

FIG. 23 is a fragmented cross-sectional side view of the vehicle seat assembly having the suspension springs shown in FIG. 22 in the initial state.

FIG. 24 is a graph showing a strain percentage and associated standard force of the singular formed cloth suspension spring with different weights.

### DETAILED DESCRIPTION

Referring to the Figures, wherein like numerals indicate like or corresponding components throughout the several views, a foam seat assembly 20 of a vehicle seat assembly 10 is shown.

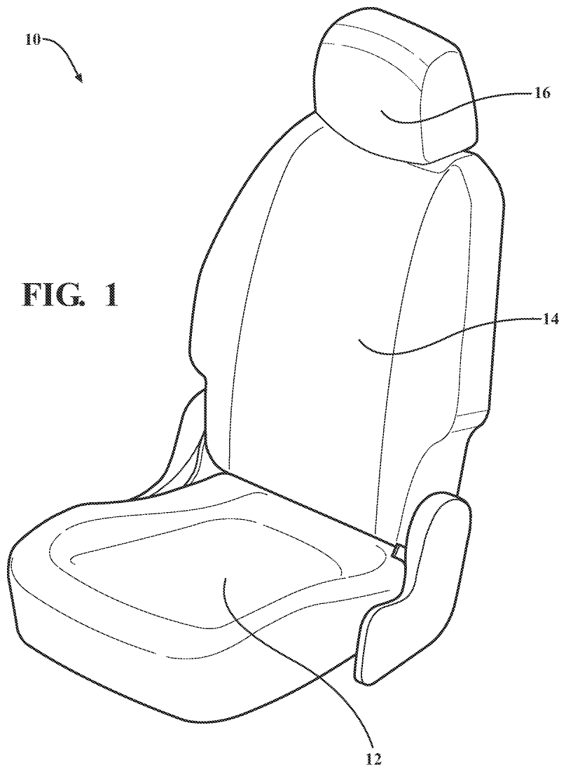

In FIG. 1, a perspective view of the vehicle seat assembly 10 with a seat bottom 12, a seat back 14, and a head restraint 16 is shown. The seat bottom 12 supports the occupant's legs, while the seatback 14 supports the occupant's back, and the head restraint 16 supports the occupant's head. The vehicle seat assembly 10 represents a conventional seat within a vehicle but it should be appreciated to those skilled in the art that the vehicle seat assembly 10 may look different depending on the application. For example, a seat in a sportscar will have the seat bottom 12 and the seat back 16 including bolstering to effectively brace an occupant during sharp turns at high speeds.

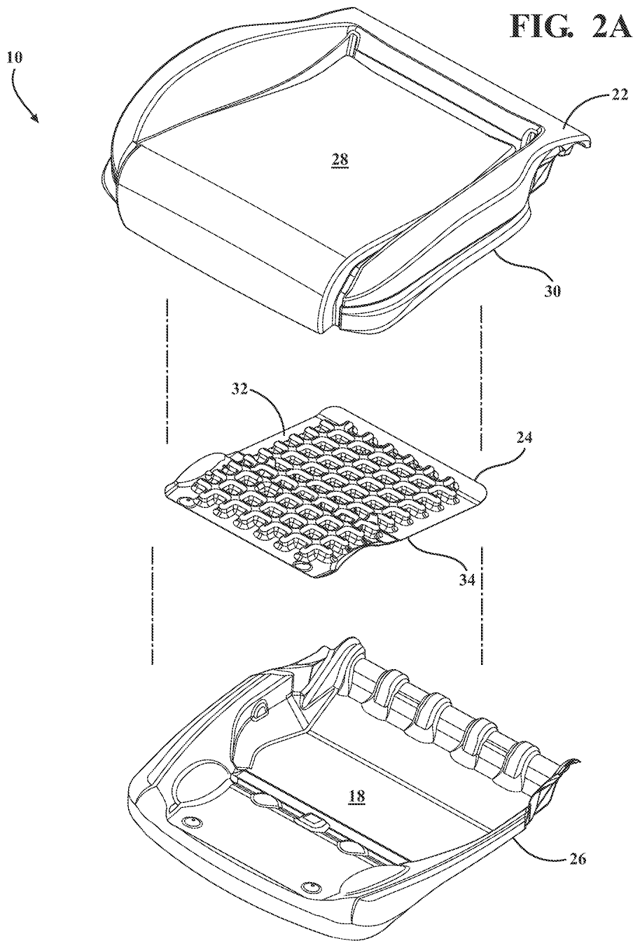

In FIG. 2A, an exploded view of the seat bottom 12 of the vehicle seat assembly 10 is shown. The vehicle seat assembly 10 comprises of a seat component 26 having a support surface 18, a foam layer 22, and a molded cloth insert (referred herein as a formed cloth 24). The foam layer 22, the formed cloth 24, and the support surface of the seat component 26 are formed and shaped to correspond or “fit with” one another. The foam layer 22 includes a top surface (referred herein as an A-surface 28) and a bottom surface (referred herein as a B-surface 30) opposite the A-surface 28. The B-surface 30 of the foam layer 22 faces the seat component 26, and more specifically faces the support surface 18 of the seat component 26. In the embodiment of FIG. 2A, the support surface 18 of the seat component 26 is rigid. Meaning, there are no springs or other suspension biasing the support surface 18. The formed cloth 24 includes an inner surface 32 and an outer surface 34. The inner surface 32 of the formed cloth 24 is attached to the B-surface 30 of the foam layer 22. The attaching of the inner surface 32 to the B-surface 30 preferably occurs during the molding of the foam layer as discussed in greater detail below.

Alternatively, as shown in FIG. 2B, the support surface 18 could be in form of a suspension mat. FIG. 2B is another exploded view of the seat bottom 12 of the vehicle seat assembly 10 including the support surface 18. The support surface 18 may be made out of plastic and located between the seat component 26 and the B-surface 30 of the foam layer 22. This type of support surface 18 is generally bendable and is used over a series of wires and springs (not shown, but is known to those skilled in the art). As such, the support surface 18 shown in FIG. 2B is capable of providing additional suspension to the vehicle seat assembly. It should be appreciated that this alternative type of support surface could also be incorporated into a seat back of the vehicle seat assembly.

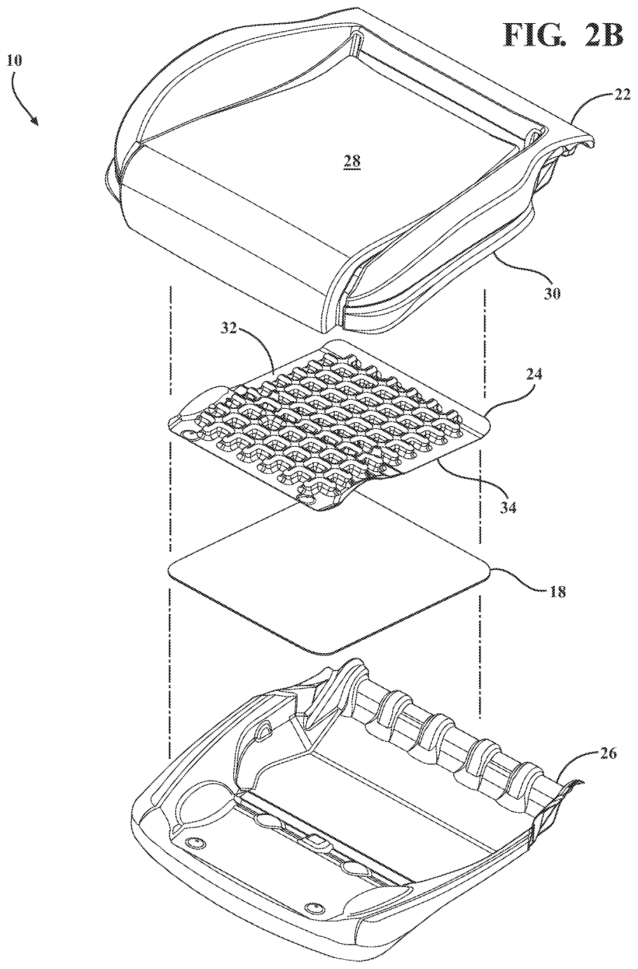

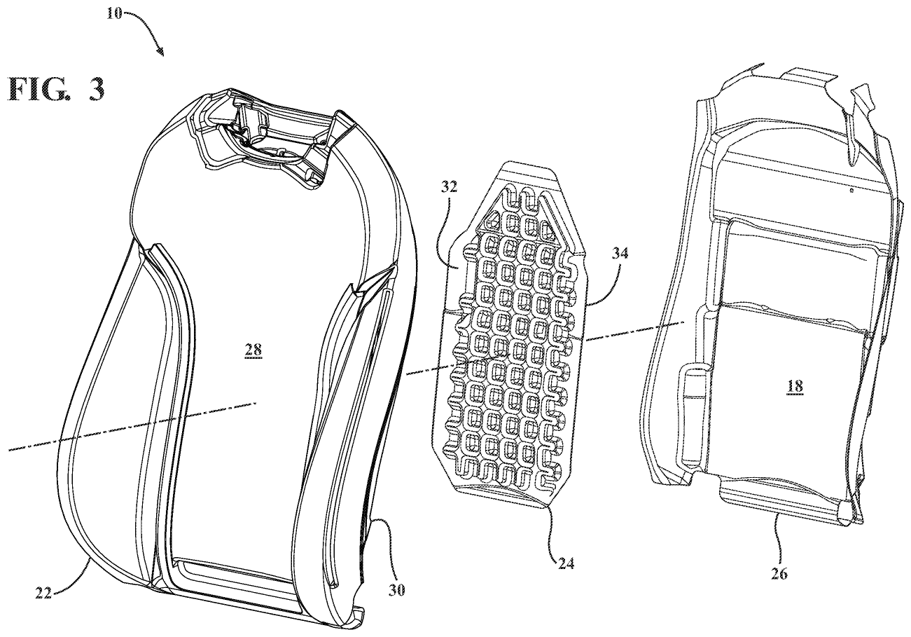

Turning to FIG. 3, an exploded view of the vehicle seat back 14 of the vehicle seat assembly 10 is shown. The vehicle seat assembly 10 shown in FIG. 3 is analogous to the vehicle seat assembly 10 shown in FIG. 2A. Meaning, the vehicle seat assembly 10 of FIG. 3 also includes a seat component 26 having a support surface, a foam layer 22, and a molded cloth insert (referred herein as a formed cloth 24). As shown in this Figure, the support surface 18 of the seat back is rigid. It should be appreciated to those skilled in the art that the goal of isolating vibrations from road noise and/or potholes through the use of suspension springs (discussed below) can be achieved with a combination of both seat bottom and seat back assemblies in FIG. 2 or 3, or it can be achieved with one of them. Additionally, it should be noted that the foam seat assembly 20 works not only to isolate road vibrations but also dampen oscillations after each dynamic input.

As shown throughout the Figures, the formed cloth 24 comprises of a plurality of fibers, which may include at least one chosen from polyester fibers, nylon fibers, and natural fibers. The plurality of fibers are shaped to define a plurality of suspension springs 36 each having a pre-defined 3-dimensional configuration defining a cavity 42. The fibers used to create the formed cloth 24 are chosen based on functionality and the properties of each type of fiber. Polyester and nylon fibers are synthetic fibers, which means they are made from chemical compounds derived from petroleum, coal, or natural gas. Natural fibers, on the other hand, come from plants or animals, such as cotton, wool, silk, or linen. For example, the plurality of fibers of the formed cloth 24 may include a nylon fiber based on the properties of nylon fibers such as strength, durability, resistance to shrinking, and moisture absorption. The plurality of fibers of the formed cloth 24 may be non-woven. The formed cloth 24 can comprise of woven or non-woven fabrics, solid or liquid polymeric binders, optional layers such as various foams, polymeric films, metallized films, powders (e.g., carbon), encapsulated particles, and be composed of various single or blends of synthetic or natural fibers. The foam layer 22 may comprise of polyurethane foam. The formed cloth 24 is formed into a 3-dimensional design using various temperatures and pressures and shaping in a compression or vacuum form mold.

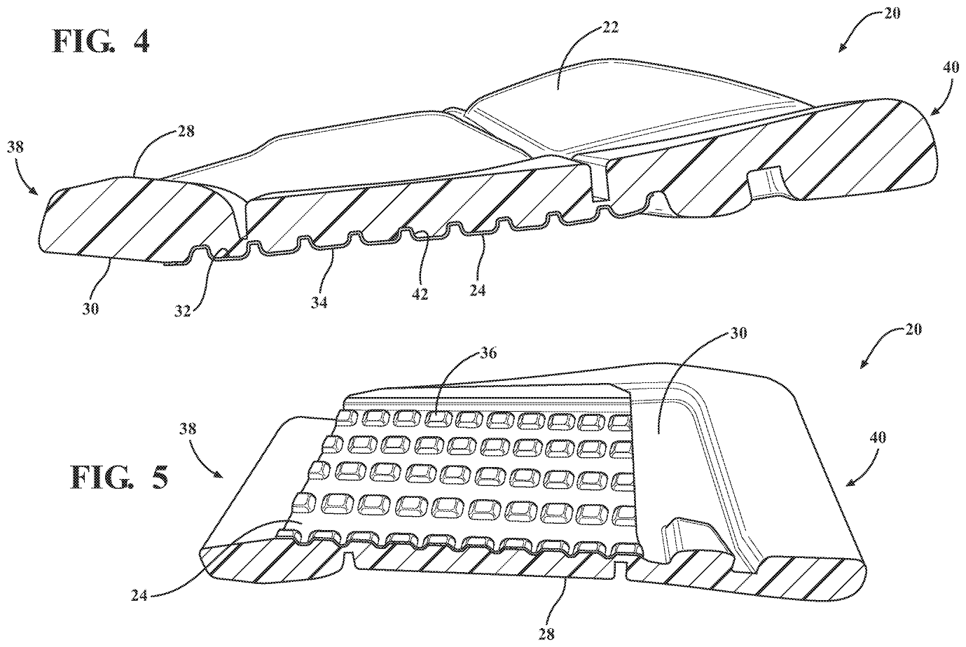

As mentioned above, the suspension springs 36 each have the pre-defined 3-dimensional configuration defining a cavity 42 (shown in FIGS. 4, 5, 8A-8B, 10A-10B, 12A-12B, 14A-14B, 16A-16B, 19, 21, and 23). Each cavity 42 is filled with a portion of the foam layer 22 and the foam layer 22 at least partially penetrates the formed cloth 24 between the inner and outer surfaces 32, 34 to further define the suspension springs 36 and to maintain the pre-defined 3-dimensional configurations of the suspension springs 36. As mentioned above, the suspension springs, with the foam layer, acts to have both a springing effect and a dampening effect in order to absorb and isolate vibrations experienced by the vehicle seat assembly. The amount of penetration depends, among other things, on the amount of fibers in the formed cloth 24. The formed cloth 24 preferably includes the plurality of fibers in an amount from 80-270 g/m². Grams per square meter is a measure of the amount of fibers in the formed cloth 24, which is used to tune the formed cloth 24 based on the required performance. This is also known in the art as the weight of the formed cloth, or the areal density. Typically, the lower the amount, the more the foam layer 22 will penetrate the formed cloth 24 between the inner and outer surfaces 32, 34. For example, if the requirement is to have higher penetration, the amount of fibers of the formed cloth 24 can be lowered such that the formed cloth 24 includes the plurality of fibers in an amount from 80-140 g/m². Or, as another example, the formed cloth 24 may include the plurality of fibers in an amount from 140-270 g/m². As another preferred example, the amount of fibers in the formed cloth 24 may include a plurality of fibers in an amount of 140 g/m². Adjusting the amount of fibers is one way to tune the formed cloth 24 for a specific performance. The lower the weight of the formed cloth, the greater the penetration of the foam layer, but a greater penetration can lead to a stiffer or more rigid overall suspension spring. As such, as part of the tuning of the suspension springs, the weight of the formed cloth is chosen with a balance against the amount of penetration of the foam layer 22. The amount of penetration is at least 5% into the formed cloth 24 or at least 10% into the formed cloth 24, but may be of a higher percentage, which may be helpful in tuning the performance of the formed cloth 24. It may be advantageous to include multiple weights (different g/m²) within the formed cloth 24. This can be done by forming a first formed cloth 24 with one given weight, and then needling a second formed cloth of a different given weight to the first formed cloth. There are other ways to tune the formed cloth 24, which are discussed below.

The formed cloth 24 may include a binder at least partially maintaining the pre-defined 3-dimensional configurations of the suspension springs 36. The formed cloth 24 may comprise at least 20% by weight of the binder. Alternatively, the formed cloth may comprise at least 30% or at least 45% by weight of the binder. The binder may be selected from a group of a co-polyester binder, a copolyamide binder, and a polyolefin binder. Binders are typically used as a process aid during the process of creating the formed cloth 24. Binders allow the formed cloth 24 to retain its shape prior to putting the formed cloth 24 into a mold and filling the mold with foam. Without this process aid, it is possible that the formed cloth 24 will not be rigid enough and may create imperfections in the final product which may adversely affect the performance of the vehicle seat assembly 10. Binders can be chosen in the type and amount depending on the specific application.

In FIG. 4, a top cross-sectional perspective view of the foam seat assembly 20 in accordance with the subject invention is shown. The foam seat assembly 20 includes a foam seat pad (referred herein as the foam layer 22). As mentioned above, the foam layer 22 includes the A-surface 28 and the B-surface 30. The A-surface 28 is oriented in the direction of the occupant and it is the surface they sit on. The current industry design standard for the thickness of automotive foam seat cushions, depending on the location within the vehicle and its support surface, is in the range of 65 mm to 125 mm. The foam seat assembly 20 shown in FIG. 4 would be considered a reduced thickness front seat cushion, however the invention can be applied in both thicker and thinner seat pad scenarios. The reduction in thickness provides the seat and interior designer the option of maintaining comfort, with a reduced thickness cushion, to address interior or vehicle designs that have reduced packaging space for the seat. It should be appreciated to those skilled in the art that FIG. 4 shows an example of the foam seat assembly 20 (without the seat component 26). However, the shape and size of the foam seat assembly 20 can vary depending on the specific vehicle for which it is designed. The foam seat assembly 20 in FIG. 4 is for use in the vehicle seat assembly 10 having the seat component 26.

As mentioned above the foam seat assembly 20 with the suspension springs 36 may rest on a rigid support surface, such as the seat component 26 shown in FIGS. 2A and 3. Alternatively, the suspension springs 36 may rest on spring biased flexible support surface such as shown in FIG. 2B. Occupant comfort includes both initial or showroom comfort, “soft feel”, which is what an occupant experiences when they first sit in the seat or over short travel distances and “firm feel” or support, which is what occupant experiences during longer drive times. There are several factors that are considered when measuring optimal occupant comfort. It should be appreciated to those skilled in the art that there are many factors to consider, however, some of these factors include: occupant subjective perception, overall seat hardness, damping of vibration inputs, and pressure distribution.

This invention may eliminate the need for a traditional suspension (e.g., sinuous springs, or a mat type) attached to the seat frame and integrates that function into the suspension springs of the seat bottom and seat back. The cushion bottom is the surface opposite the occupant and in contact with the support surface of the seat component 26, such as the rigid seat frame. Alternatively, the system could be a hybrid, with the integrated suspension springs engaging a flexible, spring biased, support surface while still contributing to minimizing bulkier traditional suspension systems.

In FIG. 5, a bottom cross-sectional perspective view of the foam seat assembly 20 is shown. The B-surface 30 of the foam layer 22 refers to the surface that faces the floor or rigid support surface of the vehicle (such as the seat component 26). FIG. 5 shows the B-surface 30 of the foam layer 22 having a section cut-out showing the molded cloth insert (referred herein as the formed cloth 24) having the plurality of suspension springs 36. As can be seen in FIG. 5, the foam layer 22 includes a front 38 and a back 40 wherein the pre-defined 3-dimensional configurations of the suspension springs 36 are arranged in linear rows from the front 38 of the foam layer 22 to the back 40 of the foam layer 22. It should be appreciated that the linear arrangement shown in FIG. 5 is one example of how the suspension springs 36 may be arranged. Other arrangements could be used, which may change the performance of the vehicle seat assembly 10 at isolating vibrations. For example, the suspension springs 36 may be arranged in diagonal rows or arranged in a non-repeating pattern.

In the preferred embodiment, the suspension springs 36 are integrally formed as part of the formed cloth 24 and are spaced apart from each other. The spacing may be entirely uniform or only partially uniform as shown in FIG. 5. The suspension springs 36 may be arranged in rows and shaped as flexible pylons to create a series of protrusions that can deflect and recover when the seat is in use. The suspension springs 36 respond to dynamic input by partially deflecting to a deflected state and recovering to an initial state relative to the support surface 18 of the seat component 26 (not shown in FIG. 5) for isolating vibrations of an occupant during use of the vehicle seat assembly 10. During a dynamic input, a portion of the outer surface of the formed cloth 24 on the suspension springs 36 engages the support surface 18 of the seat component 26. The suspension springs 36 shown in FIG. 5 show the suspension springs 36 in the initial state.

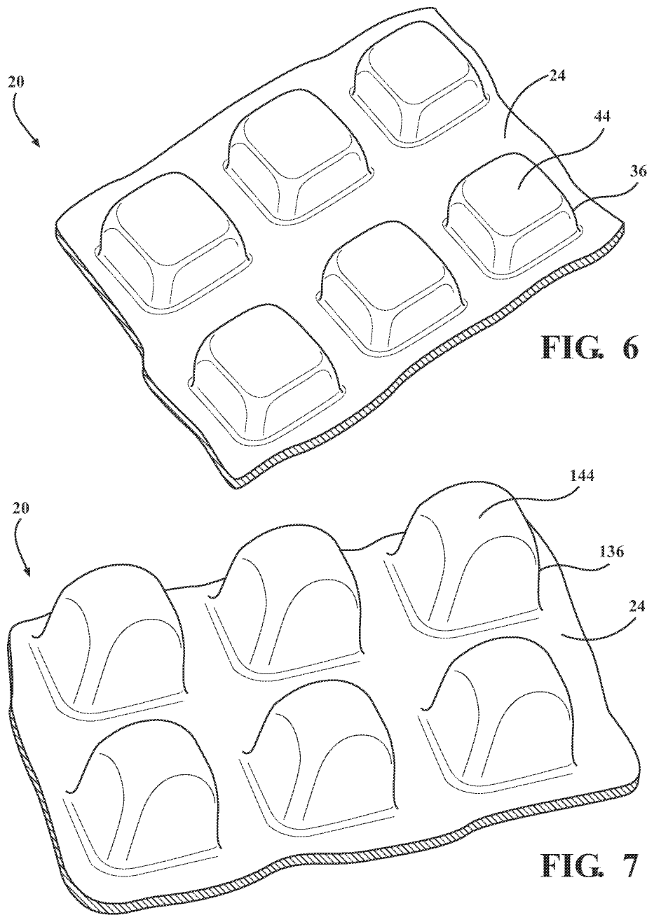

FIG. 5 shows one example of the shape of each suspension spring 36. However, it should be appreciated to those skilled in the art that the suspension springs 24 can be of any suitable shape, design, size, or configuration depending on the application and required performance. For example, the suspension springs 36 can be formed into any suitable three-dimensional shape, such as polygons, polyhedrons, tetrahedrons, cubes, pyramids, triangular prisms, hemispheres, and frustums. The suspension springs 36 may also be formed as longer continuous or semi-continuous geometries in linear, radial, or various directions. The suspension springs 36 can have pointed edges, rounded edges, or a combination of different types of edges. For example, FIG. 6 shows an enlarged fragmented perspective view of the foam seat assembly 20 showing a first embodiment of the plurality of suspension springs 36 shaped as cuboids having curved edge, which is also similar to the version of the suspension springs shown in FIG. 5. Whereas FIG. 7 shows another enlarged fragmented perspective view of the foam seat assembly 20 showing a second embodiment of the plurality of suspension springs 136 shaped as cuboids having curved edges, wherein the cuboids in FIG. 7 are slightly taller and more rounded at the top. As can be seen in FIG. 7, the pre-defined 3-dimensional configuration of at least a portion of the suspension springs 136 is a cuboid having curved edges.

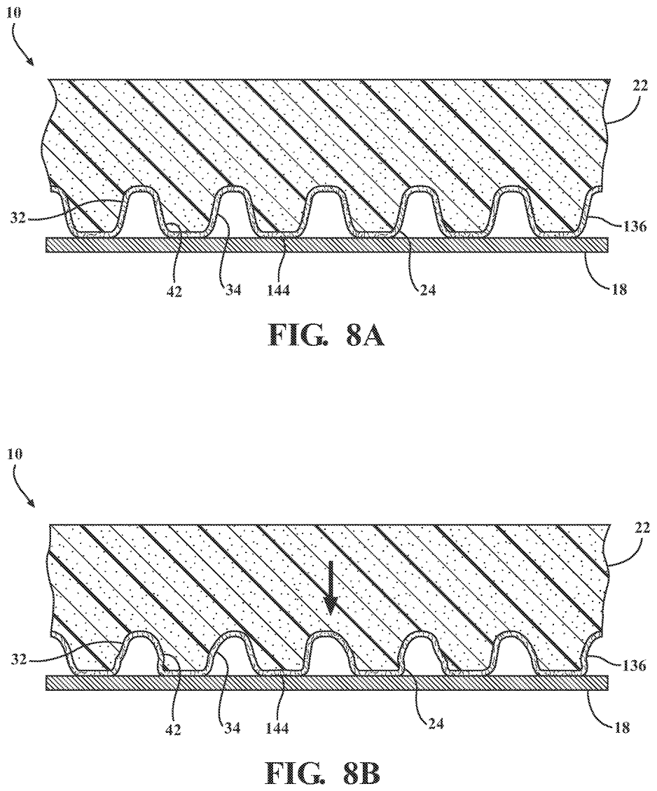

As previously discussed, the suspension springs 36 help absorb energy and isolate road vibrations from the occupant. The suspension springs 36 are activated under normal driving conditions by road surface inputs and when a high deflection scenario is reached. A high deflection scenario occurs when a vehicle experiences a sudden impact such as hitting a pothole. As a vehicle hits a pothole, the vehicle reacts to the sudden impact and the ensuing vibration is radiated throughout the body of the vehicle. FIGS. 8A and 8B help illustrate how the suspension springs 136 respond to dynamic inputs by partially deflecting to the deflected state and then recovering to the initial state. FIG. 8A is a fragmented cross-sectional side view of the vehicle seat assembly 10 having the suspension springs 136 shown in FIG. 7 in the initial state. FIG. 8B is another fragmented cross-sectional side view of the vehicle seat assembly 10 having the suspension springs 136 shown in FIG. 7 in the deflected state.

As can be seen in FIGS. 8A and 8B, the portion of the outer surface 34 of the formed cloth 24 engaging the support surface 18 of the seat component 26 is a bottom face 144 of each of the cuboids. After a high deflection driving scenario (referred herein as dynamic input), the suspension springs 136 recover into the initial state, which readies the suspension springs 136 for a subsequent dynamic input. Even during lesser dynamic inputs, vibration inputs are still transmitted through the vehicle from smooth or rough road surfaces. These inputs are repetitive and are lower in intensity, but they will contribute to occupant discomfort and fatigue if a countermeasure is not implemented. Under these low input conditions, the suspension springs 136 still perform a function by partially deflecting and recovering to help mitigate the vibration inputs. It should be appreciated to those skilled in the art that dynamic inputs can occur during many types of driving scenarios. It should also be appreciated that the ‘initial state’ can be different and dynamically change based on the input condition. As an example, the weight of an occupant could move the suspension springs from an initial state to a deflected state, and while the occupant remains seated, this deflected state becomes a new initial state. As such, when vibrations from the vehicle occur, the suspension springs are deflected again, but only recover to the ‘initial state’ as determined by the weight of the occupant. As such, during use the exact position of the ‘initial state’ of the suspension springs varies and does not necessarily equate to an unweighted rest position of the suspension springs.

The suspension springs 36 are tunable so that they can accommodate different types of vehicles and differing seat positions. It is advantageous to tune the suspension springs 36 so that they can provide the optimal performance for a given vehicle application. The suspension springs 36 are tunable by varying their size, height, surface area, and arrangement when they are formed in the formed cloth 24.

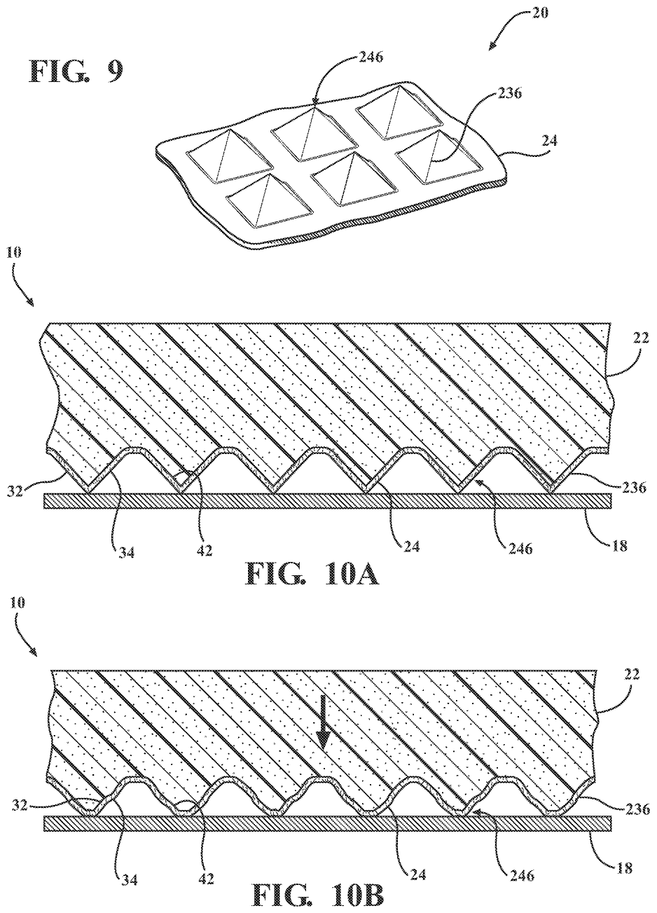

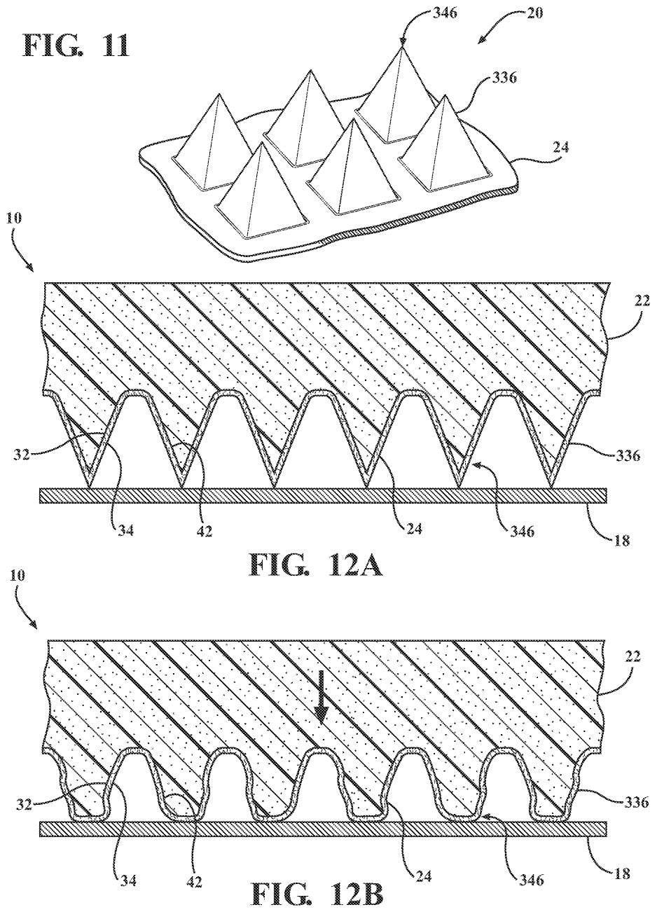

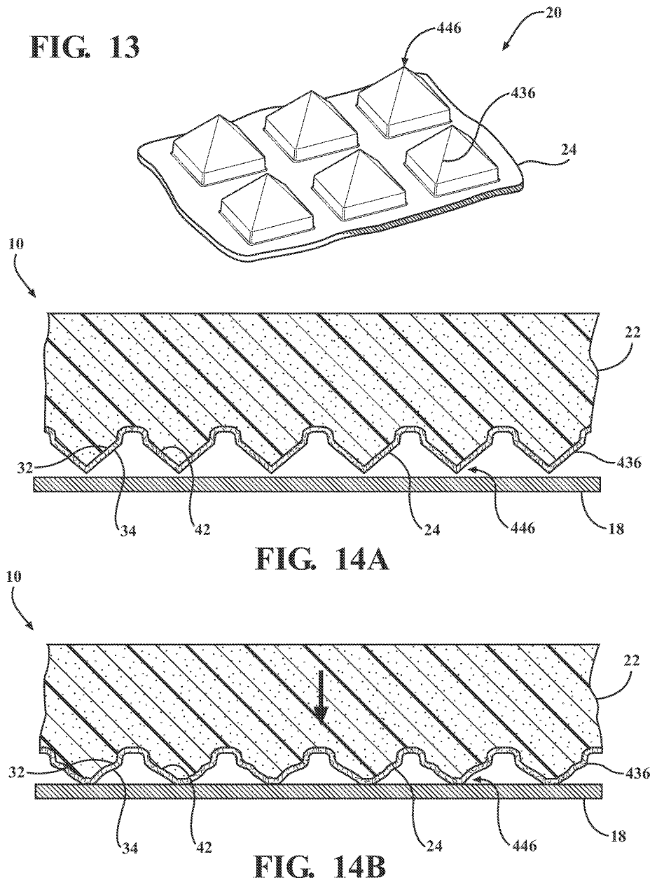

FIGS. 9-16B illustrate different shapes for the suspension springs and how they deflect into the deflected state from the initial state. Another proposed pre-defined 3-dimensional configuration of each of the suspension springs 236 is a pyramid. FIG. 9 shows another enlarged fragmented perspective view of the foam seat assembly 20 showing a third embodiment of the plurality of suspension springs 236 shaped as pyramids. The portion of the outer surface 34 of the formed cloth 24 that engages the support surface 18 of the seat component 26 is an apex 246 of each of the pyramids. FIGS. 10A and 10B help illustrate how the suspension springs 236 respond to dynamic inputs by partially deflecting to the deflected state and then recovering to the initial state. FIG. 10A is a fragmented cross-sectional side view of the vehicle seat assembly 10 having the suspension springs 236 shown in FIG. 9 in the initial state. FIG. 10B is another fragmented cross-sectional side view of the vehicle seat assembly 10 having the suspension springs 236 shown in FIG. 9 in the deflected state. As previously mentioned, increasing the height of each suspension spring 236 is one way to tune the performance. For example, FIG. 11 is another enlarged fragmented perspective view of the foam seat assembly 20 showing a fourth embodiment of the plurality of suspension springs 336 shaped as pyramids, which are slightly taller than the suspension springs 236 in FIG. 9. FIGS. 12A and 12B help illustrate how the suspension springs 336 respond to dynamic input. FIG. 12A is a fragmented cross-sectional side view of the vehicle seat assembly 10 having the suspension springs 336 shown in FIG. 11 in the initial state. FIG. 12B is another fragmented cross-sectional side view of the vehicle seat assembly 10 having the suspension springs 336 shown in FIG. 11 in the deflected state. As can be seen in FIG. 12B, the portion of the outer surface 34 of the formed cloth 24 that engages the support surface 18 of the seat component 26 is the apex 346 of each of the pyramids. Another variation of the pyramid shape is shown in FIG. 13. The pre-defined 3-dimensional configuration of each of the suspension springs 446 is a base having a pyramid FIG. 13 shows another enlarged fragmented perspective view of the foam seat assembly 20 showing a fifth embodiment of the plurality of suspension springs 436 shaped as bases with pyramids. FIG. 14A is a fragmented cross-sectional side view of the vehicle seat assembly 10 having the suspension springs 446 shown in FIG. 13 in the initial state. FIG. 14B shows another fragmented cross-sectional side view of the vehicle seat assembly 10 having the suspension springs 446 shown in FIG. 13 in the deflected state. As can be seen in FIG. 14B, the portion of the outer surface 34 of the formed cloth 24 that engages the support surface 18 of the seat component 26 is the apex 446 of each of the pyramids.

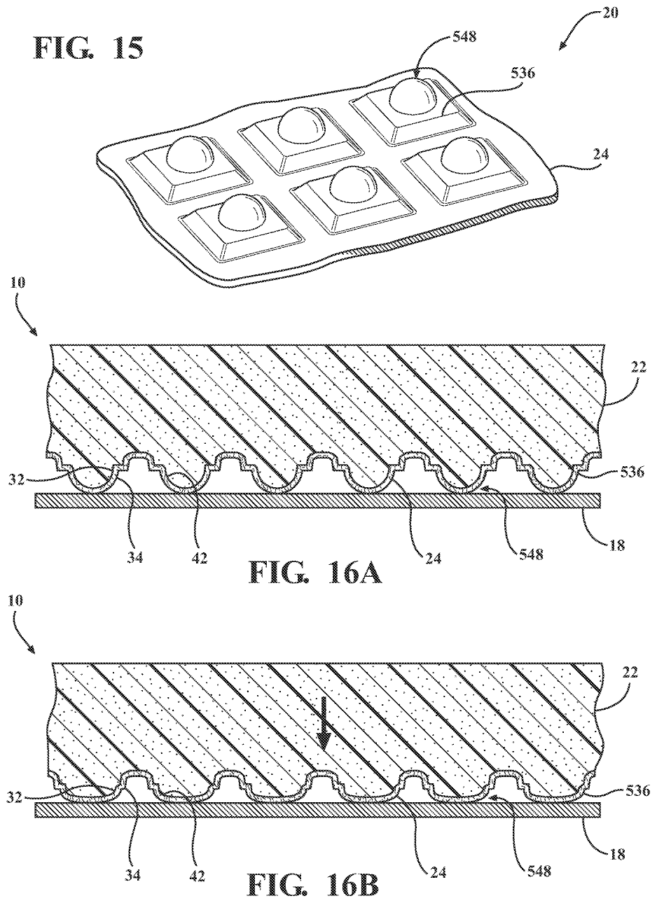

FIG. 15 is another enlarged fragmented perspective view of the foam seat assembly 20 showing a sixth embodiment of the plurality of suspension springs 536 shaped as bases with domes. As can be seen in FIG. 15, the pre-defined 3-dimensional configuration of each of the suspension springs 536 is a base having a dome. The portion of the outer surface 34 of formed cloth 24 that engages the support surface 18 of the seat component 26 is a crown 548 of each of the domes. FIGS. 16A and 16B illustrate the suspension springs 536 in the initial state and the deflected state. FIG. 16A a fragmented cross-sectional side view of the vehicle seat assembly 10 having the suspension springs 536 shown in FIG. 15 in the initial state. FIG. 16B is another fragmented cross-sectional side view of the vehicle seat assembly 10 having the suspension springs 536 shown in FIG. 15 in the deflected state.

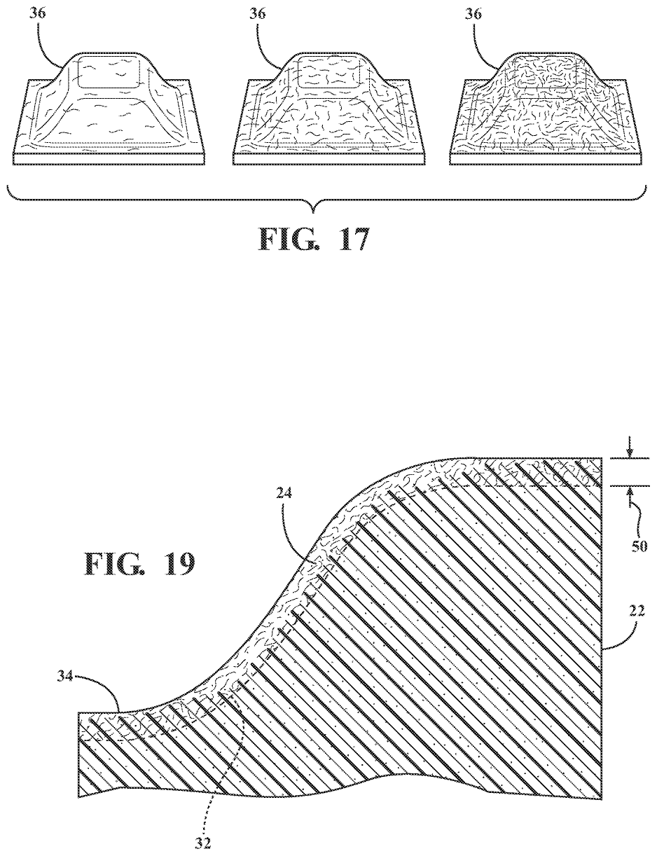

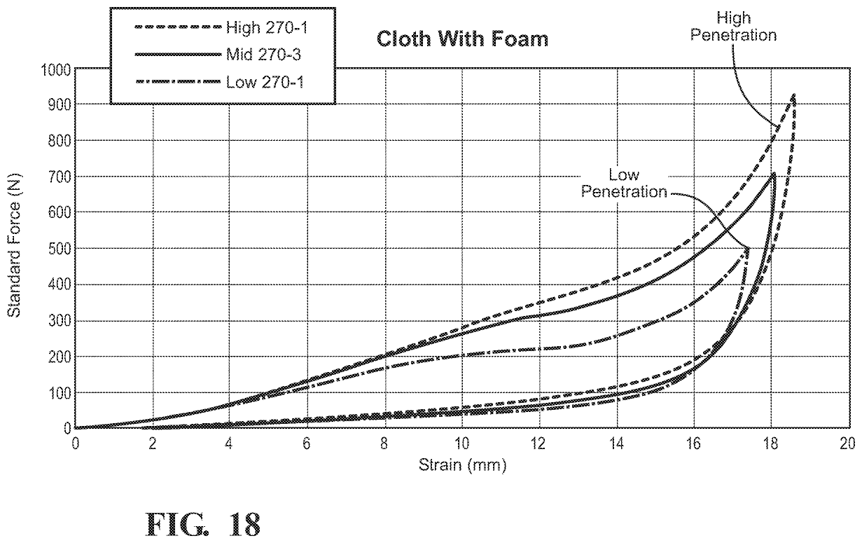

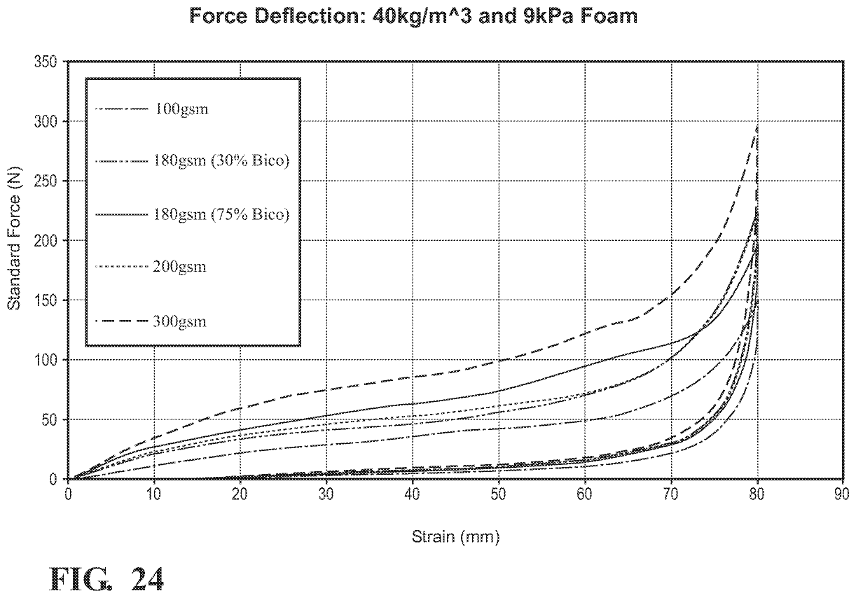

As previously mentioned, tuning the performance of the foam seat assembly 20 is important to achieve desired performance. Tuning can be done by varying the attributes of the suspension springs 36 such as the height or the size or by varying the configuration of how the suspension springs 36 are arranged. There is another way to tune the performance by varying the penetration. The formed cloth 24 has a thickness 50 (shown various Figures, but perhaps best in FIG. 19) defined between the inner and outer surfaces 32, 34 and a portion of the foam layer 22 penetrates the inner surface 32 of the formed cloth 24 at least 5% of the thickness 50 of the formed cloth 24 or at least 10% of the thickness 50 of the formed cloth 24. As shown in FIG. 19, it should be appreciated that the penetration could be higher than 5% of the thickness 50 of the formed cloth 24. FIG. 17 shows a perspective view of three sample portions of the foam seat assembly 20 illustrating the three levels of foam layer penetration into the formed cloth 24 as found in the graph in FIG. 18. As can be seen in FIG. 17, the left suspension spring 36 shows low penetration with light coloring. The middle suspension spring 36 shows medium penetration, and the right suspension spring 36 shows high penetration. It should be appreciated that the suspension springs 36 shown in FIG. 17 are examples of suspension springs 36 that are similar to ones shown in FIG. 6, but with sides that are more sloped. The penetration of the foam layer 22 into the thickness between the inner and outer surfaces 32, 34 of the formed cloth 24 affects the amount of force each given suspension spring 36 can withstand prior to collapsing. This is shown in FIG. 18. FIG. 18 shows a graph showing the effect of different levels of the foam layer 22 penetrating into the formed cloth 24. The graph shows the formed cloth 24 having the amount of fibers of 270 g/m² with three levels of penetration: high, mid, and low. As can be seen, the higher the penetration, the higher the standard force in Newtons each suspension spring can withstand. As an additional illustration, FIG. 24 shows various weights of the formed cloth 24 ranging from 100 g/m² to 300 g/m² responding to percentages of strain. It should be appreciated that “gsm” means gram-per-square-meter. As can be seen in FIG. 24, the higher the weight, generally the more standard force the formed cloth suspension spring 36 can withstand as a higher percentage of strain is applied to the formed cloth suspension spring 36.

Referring to FIG. 19, which shows an enlarged fragmented cross-sectional side view of the suspension spring 36 illustrating varying percentages of penetration of the foam layer 22 into the formed cloth 24. The formed cloth 24 has the thickness 50 defined between the inner and outer surfaces 32, 34 and the portion of the foam layer 22 penetrates the inner surface 32 of the formed cloth 24 at different percentages of the thickness 50 of the formed cloth 24 along the pre-defined 3-dimensional configurations of the suspension springs 36. As can be seen in FIG. 19, the penetration may not be uniform across the suspension spring 36. This could be desirable or undesirable depending on the application. FIG. 19 is included to illustrate the possibility of different penetrations of the foam layer into the formed cloth 24. For example, the suspension spring 36 in FIG. 19 has more penetration of the foam layer 22 in areas where the suspension spring's 36 outer surface 34 is flatter. This is at the left part of the suspension spring 36 prior to the shape curving upwards and then the outer layer 34 is once again flatter towards the top of the suspension spring 36. This occurs during the molding process when the B-surface 30 of the foam layer 22 is attached to the inner surface 32 of the formed cloth 24.

The portion of the foam layer 22 that penetrates the inner surface 32 of the formed cloth 24 is impermeable. As discussed above, FIG. 19 show varying amounts of penetration of the foam layer 22 into the thickness defined by the inner and outer surfaces 32, 34 of the formed cloth 24. The foam layer 22 may be made out of polyurethane foam, which can be permeable. However, when the portion of the foam layer 22 penetrates the inner surface 32 of the formed cloth 24, that portion becomes impermeable. During the molding process as described above, the B-surface 30 of the foam layer 22 is attached to the inner surface 32 of the formed cloth 24. This may be advantageous for certain applications of this disclosure. For example, as the suspension springs 36 deflect to the deflected state, air may escape and it may be advantageous to have that air escaping toward the occupant and not toward the seat component 26.

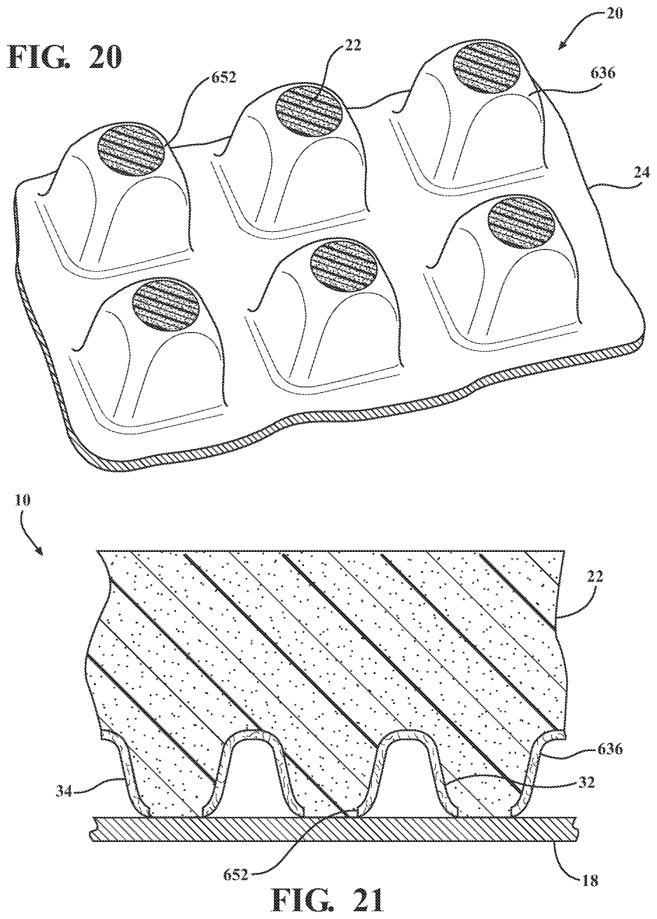

As previously mentioned, there are different ways to tune the performance of the foam seat assembly 10, which is important to achieve desired performance. Yet another way to tune the performance is to have the cavity of the suspension spring have an opening 52 extending through the inner and outer surfaces of the formed cloth. As can be seen in FIG. 20, the formed cloth 24 comprises the plurality of fibers shaped to define the plurality of suspension springs 636 each having the pre-defined 3-dimensional configuration defining the cavity 42 with the cavity having the opening 52 extending through the inner and outer surfaces 32, 34. Each cavity 42 is filled with the portion of the foam layer 22. The foam layer 22 penetrates the formed cloth 24 between said inner and outer surfaces 32, 34 to further define the suspension springs 636 and to maintain the pre-defined 3-dimensional configurations of the suspension springs 636, and the foam layer 22 extends at least into the opening 52 of the formed cloth 24. As can be seen in FIG. 20, the openings 52 in each suspension spring 636 show the foam layer 22. As discussed above, as the suspension springs 636 respond to dynamic input by deflecting to the deflected state and recover to the initial state, air will escape. It may be advantageous to control how the air escapes and the openings 52 in the suspension springs 636 allow for an air passageway. on the top of each suspension spring 636, which is illustrated in FIG. 20. FIG. 20 is an enlarged fragmented perspective view of the foam seat assembly 20 showing a seventh embodiment of the plurality of suspension springs 636 shaped as cuboids having curved edges and with openings 52.

The suspension springs 636 respond to dynamic input by partially deflecting to the deflected state and recovering to the initial state for isolating vibrations of the occupant during use of the foam seat assembly 20 when at least one of the portion of the suspension springs 636 and the portion of the foam layer 22 extending into the opening 52 engage the support surface 18 of the seat component 26 and move between the initial and deflected states relative to the support surface 18 of the seat component 26. An illustration of the suspension springs 636 in the initial state can be seen in FIG. 21. FIG. 21 is a fragmented cross-sectional side view of the vehicle seat assembly 10 having the suspension springs 636 shown in FIG. 20 in the initial state.

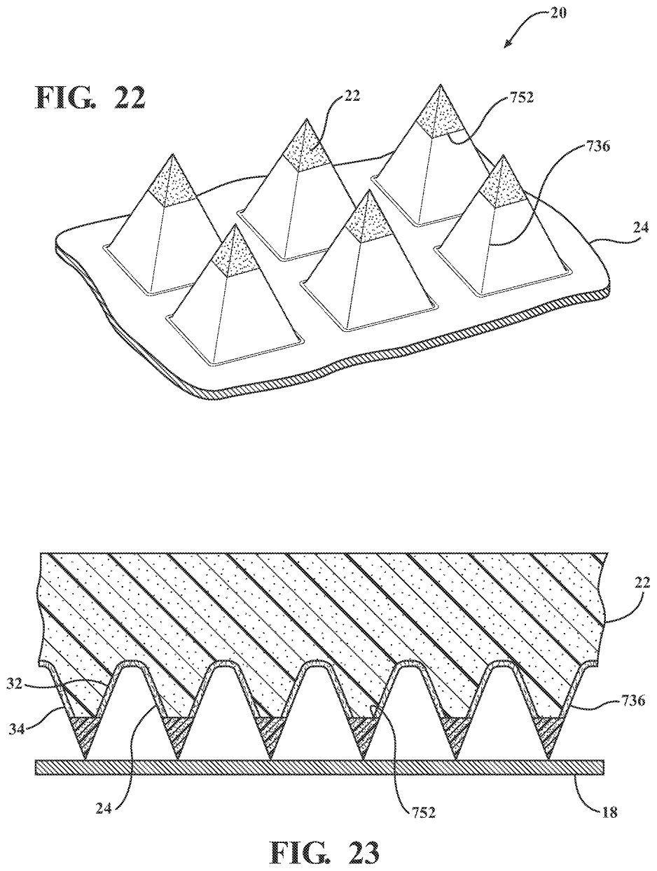

The foam layer 22 may extend through the opening 52 in the formed cloth 24 to form an external foam portion 54 integrally connected to the foam layer 22 and the formed cloth 24. An example can be seen in FIG. 22. FIG. 22 is an enlarged fragmented perspective view of the foam seat assembly 20 showing an eighth embodiment of the plurality of suspension springs 736 shaped as pyramids with openings 52. Essentially, the top portion of each pyramid in FIG. 22 is the foam layer 22 instead of the formed cloth 24.

Another way to include openings 52 into the suspension springs 736 is to include a plurality of openings 52 in each suspension spring 736. The cavity 52 may have a plurality of openings 52 extending through the inner and outer surfaces 32, 34 and the foam layer 22 extends at least into each of the openings 52 of the formed cloth 24. Having a plurality of openings 52 can help further tune the performance of the foam seat assembly 20 in isolating vibrations. It is to be appreciated that the suspension springs having the openings may be of any suitable configuration or design.

Conventional vehicle applications typically contain a suspension system within a seat frame by using metal springs. The suspension springs 36 eliminate the need for a conventional suspension system within a seat frame because the integrated suspension springs 36 provide the isolation of road vibrations from the occupant. It should be appreciated by those skilled in the art that the amount of suspension needed to maintain occupant comfort and safety differs from vehicle to vehicle. Larger and heavier vehicles need different vibration dampening than smaller and lighter vehicles. The removal of a conventional suspension system reduces the height required to house a seat within a vehicle. This helps accommodate the automotive industry trend of creating vehicles with sleeker designs having less height within the cabin.

An exemplary embodiment of the molded cloth insert 24 with suspension springs 36 is shown in FIGS. 4 and 5. However, the embodiments discussed herein are not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

1. A vehicle seat assembly comprising:
a seat component having a support surface;
a foam layer having an A-surface and a B-surface opposite said A-surface with said B-surface facing said support surface of said seat component; and
a formed cloth having an inner surface and an outer surface with said inner surface attached to said B-surface of said foam layer, and said formed cloth comprising a plurality of fibers shaped to define a plurality of suspension springs each having a pre-defined 3-dimensional configuration defining a cavity;
wherein each cavity is filled with a portion of said foam layer and said foam layer at least partially penetrates said formed cloth between said inner and outer surfaces to further define said suspension springs and to maintain said pre-defined 3-dimensional configurations of said suspension springs;
wherein a portion of said outer surface of said formed cloth on said suspension springs engages said support surface of said seat component; and
wherein said suspension springs respond to dynamic input by partially deflecting to a deflected state and recovering to an initial state relative to said support surface of said seat component for isolating vibrations of an occupant during use of the vehicle seat assembly.

2-10. (canceled)

11. The vehicle seat assembly as set forth in claim 1 wherein said pre-defined 3-dimensional configuration of at least a portion of said suspension springs is a cuboid having curved edges and wherein said portion of said outer surface of said formed cloth engaging said support surface of said seat component is a bottom face of each of said cuboids.

12. (canceled)

13. The vehicle seat assembly as set forth in claim 1 wherein said pre-defined 3-dimensional configuration of each said suspension springs is a pyramid and wherein said portion of said outer surface of said formed cloth that engages said support surface of said seat component is an apex of each of said pyramids.

14-16. (canceled)

17. The vehicle seat assembly as set forth in claim 1 wherein said pre-defined 3-dimensional configuration of each said suspension springs is a base having a dome and wherein said portion of said outer surface of said formed cloth that engages said support surface of said seat component is a crown of each of said domes.

18-19. (canceled)

20. The vehicle seat assembly as set forth in claim 1 wherein said foam layer includes a front and a back wherein said pre-defined 3-dimensional configurations of said suspension springs are arranged in linear rows from said front of said foam layer to said back of said foam layer.

21. (canceled)

22. A foam seat assembly for use in a vehicle seat assembly having a seat component defining a support surface, said foam seat assembly comprising:
a foam layer having an A-surface and a B-surface opposite said A-surface with said B-surface adapted to face the support surface of the seat component; and
a formed cloth having an inner surface and an outer surface with said inner surface attached to said B-surface of said foam layer, and said formed cloth comprising a plurality of fibers shaped to define a plurality of suspension springs each having a pre-defined 3-dimensional configuration defining a cavity;
wherein each cavity is filled with a portion of said foam layer and said foam layer penetrates said formed cloth between said inner and outer surfaces to further define said suspension springs and to maintain said pre-defined 3-dimensional configurations of said suspension springs; and
wherein said suspension springs respond to dynamic input by partially deflecting to a deflected state and recovering to an initial state for isolating vibrations of an occupant during use of the foam seat assembly when a portion of said suspension springs engage the support surface of the seat component and move between said initial and deflected states relative to the support surface of the seat component.

23. The foam seat assembly as set forth in claim 22 wherein said formed cloth has a thickness defined between said inner and outer surfaces, and wherein said portion of said foam layer penetrates said inner surface of said formed cloth at least 5% of said thickness of said formed cloth.

24. The foam seat assembly as set forth in claim 22 wherein said formed cloth includes said plurality of fibers in an amount from 80-270 g/m².

25. The foam seat assembly as set forth in claim 22 wherein said formed cloth has a thickness defined between said inner and outer surfaces, and wherein said portion of said foam layer penetrates said inner surface of said formed cloth at different percentages of said thickness of said formed cloth along said pre-defined 3-dimensional configurations of said suspension springs.

26. The foam seat assembly as set forth in claim 22 wherein said portion of said foam layer that penetrated said inner surface of said formed cloth is impermeable.

27. The foam seat assembly as set forth in claim 22 wherein said formed cloth further comprises of a binder at least partially maintaining said pre-defined 3-dimensional configurations of said suspension springs.

28. The foam seat assembly as set forth in claim 27 wherein said formed cloth comprises at least 20% by weight of said binder.

29. The foam seat assembly as set forth in claim 22 wherein said plurality of fibers comprise at least one chosen from polyester fibers, nylon fibers, and natural fibers.

30. The foam seat assembly as set forth in claim 22 wherein said formed cloth includes said plurality of fibers in an amount from 80-140 g/m².

31. The foam seat assembly as set forth in claim 22 wherein said formed cloth includes said plurality of fibers in an amount of 140-270 g/m²

32. The foam seat assembly as set forth in claim 22 wherein said formed cloth includes said plurality of fibers in an amount of 140g/m².

33. The foam seat assembly as set forth in claim 22 wherein said pre-defined 3-dimensional configuration of at least a portion of said suspension springs is a cuboid having curved edges.

34. The foam seat assembly as set forth in claim 22 wherein said pre-defined 3-dimensional configuration of each said suspension springs includes a pyramid.

35. The foam seat assembly as set forth in claim 22 wherein said pre-defined 3-dimensional configuration of each said suspension springs is a base having a dome.

36. The foam seat assembly as set forth in claim 22 wherein said plurality of fibers of said formed cloth are non-woven.

37. The foam seat assembly as set forth in claim 22 wherein said plurality of fibers of said formed cloth are woven.

38. A foam seat assembly for use in a vehicle seat assembly having a seat component defining a support surface, said foam seat assembly comprising:
a foam layer having an A-surface and a B-surface opposite said A-surface with said B-surface adapted to face the support surface of the seat component; and
a formed cloth having an inner surface and an outer surface with said inner surface attached to said B-surface of said foam layer, and said formed cloth comprising a plurality of fibers shaped to define a plurality of suspension springs each having a pre-defined 3-dimensional configuration defining a cavity with said cavity having an opening extending through said inner and outer surfaces;
wherein each cavity is filled with a portion of said foam layer, said foam layer penetrating said formed cloth between said inner and outer surfaces to further define said suspension springs and to maintain said pre-defined 3-dimensional configurations of said suspension springs, and said foam layer extending at least into said opening of said formed cloth;
wherein said suspension springs respond to dynamic input by partially deflecting to a deflected state and recovering to an initial state for isolating vibrations of an occupant during use of the foam seat assembly when at least one of a portion of said suspension springs and a portion of said foam layer extending into said opening engage the support surface of the seat component and move between said initial and deflected states relative to the support surface of the seat component.

39. The foam seat assembly as set forth in claim 38 wherein said foam layer extends through said opening in said formed cloth to form an external foam portion integrally connected to said foam layer and said formed cloth.

40. The foam seat assembly as set forth in claim 38 wherein said cavity has a plurality of openings extending through said inner and outer surfaces and said foam layer extends at least into each of said openings of said formed cloth.

41. The foam seat assembly as set forth in claim 38 wherein said formed cloth has a thickness defined between said inner and outer surfaces, and wherein said portion of said foam layer penetrates said inner surface of said formed cloth at least 5% of said thickness of said formed cloth.

42. The foam seat assembly as set forth in claim 38 wherein said formed cloth has a thickness defined between said inner and outer surfaces, and wherein said portion of said foam layer penetrates said inner surface of said formed cloth at different percentages of said thickness of said formed cloth along said pre-defined 3-dimensional configurations of said suspension springs.

43-46. (canceled)
